(19) United States
(12) Patent Application Publication
(10) Pub. No.: US 2008/0295527 A1
(43) Pub. Date: Dec. 4, 2008

(54) LNG TANK SHIP WITH NITROGEN GENERATOR AND METHOD OF OPERATING THE SAME

(75) Inventors: Jung Han Lee, Geoje-si (KR); Jong Hyun Park, Geoje-si (KR); Young Soo Kim, Geoje-si (KR); Hyun Ki Park, Geoje-si (KR); Jin Yul Yu, Geoje-si (KR); Hyun Jin Kim, Gwangju (KR)

Correspondence Address: KNOBBE MARTENS OLSON & BEAR LLP, 2040 MAIN STREET, FOURTEENTH FLOOR, IRVINE, CA, 92614, US

(73) Assignee: DAEWOO SHIPBUILDING & MARINE ENGINEERING CO., LTD., SEOUL (KR)

(21) Appl. No.: 11/971,103

(22) Filed: Jan. 8, 2008

(30) Foreign Application Priority Data
May 31, 2007 (KR) 10-2007-0053592

(51) Int. Cl. F17C 9/02

(52) U.S. Cl. 62/50.2

(57) ABSTRACT

Disclosed is an apparatus for producing nitrogen equipped in a marine structure such as a liquefied natural gas regasification vessel (LNG RV) and a floating storage and regasification unit (FSRU), and a method for producing nitrogen in a marine structure using the apparatus. The apparatus for producing nitrogen equipped in a flowing marine structure produces nitrogen to be mixed with natural gas to be supplied to consumers after regasification. The floating marine structure in which the apparatus is equipped has an LNG regasification facility for compressing the LNG stored in a storage tank using a high-pressure pump and then vaporizing the LNG into natural gas in a vaporizer to supply natural gas to consumers. The apparatus for producing nitrogen secures cold heat necessary to produce nitrogen using the LNG supplied from the storage tank.

### CROSS-REFERENCE TO RELATED PATENT APPLICATIONS

This application claims priority to and the benefit of Korean Patent Application No. 10-2007-0053592, filed May 31, 2007, the disclosure of which is incorporated herein by references in its entirety.

### BACKGROUND

1. Field

The present disclosure relates to an offshore LNG plant such as a liquefied natural gas regasification vessel (LNG RV) and a floating storage and regasification unit (FSRU), and more particularly, to an offshore LNG plant with a nitrogen generator.

2. Discussion of the Related Technology

Recently, worldwide consumption of natural gas has sharply increased. Natural gas is transported in a gas state through a gas pipeline on land or under the sea, or transported long distances to consumers by being stored as liquefied natural gas in an LNG carrier. The liquefied natural gas (LNG) is obtained by cooling natural gas at a cryogenic temperature (approximately −163° C.), and since the volume of LNG is reduced to approximately 1/600 of the volume of natural gas in a gas state, LNG is suitable for transportation over long distances by sea.

An LNG carrier, which is to voyage with LNG loaded therein and to unload LNG at destinations on land, includes an LNG storage tank (often called “a cargo space”) which can withstand cryogenic temperature of the LNG stored therein. Generally, such an LNG carrier unloads LNG in a liquid state on land, and the unloaded LNG is regasified or vaporized by an LNG regasification facility installed on land and then transported to consumers of natural gas through gas pipelines.

It is economically advantageous to install such a land-based LNG regasification facility at places with a steady demand for natural gas because of a well-established natural gas market. However, because of high installation and maintenance costs, it is very disadvantageous to install a land-based LNG regasification facility at places with a fluctuating demand for natural gas which varies seasonally, temporarily or periodically.

In particular, in case where a land-based LNG regasification facility is destroyed by a natural disaster, even though an LNG carrier arrives at a destination with LNG loaded therein, the LNG cannot be unloaded or regasified. Consequently, transportation of natural gas using a typical LNG carrier has limitations.

The foregoing discussion is to provide general background information, and does not constitute an admission of prior art.

### SUMMARY

One aspect of the invention provides an offshore LNG plant, which comprises: an LNG containing tank; an N₂ generator configured to separate N₂ from air to a predetermined level of concentration; a LNG processor in fluid communication with the tank and the N₂ generator, wherein the LNG processor is configured to vaporize and dilute a supply of LNG from the tank with a supply of N₂ from the N₂ generator so as to produce a vaporized and diluted form of LNG; and a pipe configured to transfer the vaporized and diluted form of LNG from the LNG processor to an onshore network for supplying vaporized LNG.

In the foregoing plant, the LNG processor may comprise: a mixer configured to mix the supply of LNG from the tank with the supply of N₂ from the N₂ generator so as to produce a diluted LNG; and a vaporizer configured to vaporize the diluted LNG so as to produce the vaporized and diluted form of LNG, wherein the vapor supply pipe may be configured to connect to an outlet of the vaporizer. The LNG processor may comprise: a vaporizer configured to vaporize the supply of LNG from the tank; and a mixer configured to mix the vaporized LNG with the supply of N₂ from the N₂ generator so as to produce the vaporized and diluted form of LNG, wherein the vapor supply pipe may be configured to connect to an outlet of the mixer.

Still in the foregoing plant, the offshore LNG plant may be floating on water. The offshore LNG plant may be fixed to the seabed. The offshore LNG plant may be substantially stationary relative to the onshore network. The predetermined level of N₂ concentration may be from about 85 mole % to about 99 mole %. The predetermined level of N₂ concentration may be lower than 95 mole %. The offshore LNG plant may be provided in an LNG tank ship. The LNG tank may have a containing capacity greater than about 10,000 m³. The LNG tank may have a containing capacity greater than about 100,000 m³.

Another aspect of the invention provides an LNG supply system, which comprise: an offshore LNG plant comprising an LNG containing tank, an N₂ generator configured to separate N₂ from air to a predetermined level of concentration, a LNG processor in fluid communication with the tank and the N₂ generator, wherein the LNG processor is configured to vaporize and dilute a supply of LNG from the tank with a supply of N₂ from the N₂ generator so as to produce a vaporized and diluted form of LNG; an onshore network for supplying vaporized LNG to consumers; and a pipe interconnecting the offshore LNG plant to the onshore network and for transferring the vaporized and diluted form of LNG from the offshore LNG plant to the onshore network.

In the foregoing system, the system does not comprise an onshore LNG tank containing liquid LNG with an associated liquefaction plant. The system does not comprise an onshore LNG tank containing liquid LNG with a storage capacity larger than 10,000 m³. The system does not comprise a liquefaction plant with a liquefaction capacity greater than 300 kg/hr.

Still another aspect of the invention provides a method of supplying LNG, which comprises: providing LNG contained in an offshore LNG tank; producing N₂ to a predetermined level of concentration in an offshore N₂ generator, which separates N₂ from air; vaporizing and diluting, in an offshore LNG processor, a supply of LNG from the offshore LNG tank with a supply of N₂ from the offshore N₂ generator, thereby producing vaporized and diluted LNG; and transferring, via a pipe, the vaporized and diluted LNG from the offshore LNG processor to an onshore valve connected to a vaporized LNG distribution network.

In the foregoing method, the offshore LNG tank, the offshore N₂ generator, the offshore LNG processor may be provided in an LNG tank ship. The offshore LNG tank, the offshore N₂ generator, the offshore LNG processor may be provided in a substantially stationary offshore LNG plant. The method does not comprise liquefying the vaporized and diluted LNG to store liquid LNG in an onshore LNG tank. The method does not comprise liquefying the vaporized and diluted LNG onshore with a liquefaction capacity greater than 3000 kg/hr.

A further aspect of the invention provides a marine structure, which comprises: an LNG tank storing liquefied natural gas (LNG); an LNG vaporizer configured to vaporize LNG from the tank; and a N₂ apparatus configured to provide N₂ to dilute the LNG prior to supplying to consumers, the apparatus comprising a distillation tower configured to separate N₂ from air, and an LNG heat exchanger configured to use LNG from the tank so as to cool the separated N₂ to condense at least part of the separated N₂, wherein the apparatus is configured to return at least part of the cooled N₂ to the distillation tower so as to cool air introduced into the distillation tower.

In the foregoing structure, the apparatus may further comprise a vapor separator configured to separate a gaseous portion from the cooled N₂; and wherein the marine structure further comprises a N₂ absorber configured to absorb the gaseous N₂ for adding to LNG prior to LNG vaporization. The marine structure may further comprise a N₂ exhaust valve configured to discharge the N₂, which has not been absorbed in the N₂ absorber. The marine structure may further comprise a N₂ pipe configured to return the N₂, which has not been absorbed in the N₂ absorber, to the distillation tower. The marine structure may further comprise a N₂ mixer configured to mix LNG prior to vaporization with at least part of the condensed N₂, which has not been returned to the distillation tower.

An aspect of the present invention provides an apparatus for producing nitrogen which is equipped in a marine structure, and which does not occupy a large installation space, and which can supply a necessary amount of nitrogen to natural gas supplied to consumers, and a method for producing nitrogen in a marine structure using the apparatus.

An embodiment of the present invention provides an apparatus for producing nitrogen to be mixed with natural gas to be supplied to consumers after regasification, which is equipped in a floating marine structure having an LNG regasification facility for compressing the LNG stored in a storage tank using a high-pressure pump and then vaporizing the LNG into natural gas in a vaporizer to supply natural gas to consumers, the apparatus being characterized by securing cold heat necessary to produce nitrogen using the LNG supplied from the storage tank.

Another embodiment of the present invention provides an apparatus for producing nitrogen to be mixed with natural gas to be supplied to consumers after regasification, which is equipped in a marine structure having an LNG regasification facility for compressing the LNG stored in a storage tank using a high-pressure pump and then vaporizing the LNG into natural gas in a vaporizer to supply natural gas to consumers, the apparatus comprising: a distillation tower for separating nitrogen from air; and an LNG heat exchanger for condensing the nitrogen separated in the distillation tower, wherein cold heat needed for cooling air to separate nitrogen in the distillation tower is secured by returning at least a portion of the liquefied nitrogen, which has been condensed in the LNG heat exchanger, to the distillation tower.

Another embodiment of the present invention provides a method for producing nitrogen using an apparatus for producing nitrogen to be mixed with natural gas to be supplied to consumers after regasification, which is equipped in a marine structure having an LNG regasification facility for compressing the LNG stored in a storage tank using a high-pressure pump and then vaporizing the LNG into natural gas in a vaporizer to supply natural gas to consumers, the method being characterized by using the LNG supplied from the storage tank so as to secure cold heat necessary to produce nitrogen.

### BRIEF DESCRIPTION OF THE DRAWINGS

The above and other aspects, features and advantages of the present invention will become apparent from the following description of embodiments given in conjunction with the accompanying drawings, in which:

FIG. 1 is a schematic diagram of an LNG tank ship with an apparatus for producing nitrogen according to an embodiment of the present invention; and

FIG. 2 is a schematic diagram of an LNG tank ship with an apparatus for producing nitrogen according to an embodiment of the present invention.

### DETAILED DESCRIPTION OF EMBODIMENTS

Hereinafter, embodiments of the present invention will be described in more detail with reference to the accompanying drawings.

In one embodiment of the invention, an on-board LNG regasification system is developed so that an LNG carrier or a marine floating storage may be provided with an LNG regasification facility to regasify liquefied natural gas on board and to supply natural gas obtained by the regasification to consumers on land. Some examples of marine structures provided with such an LNG regasification facility are an LNG RV and an LNG FSRU.

Occasionally, an appropriate amount of nitrogen gas is desirable to be mixed with natural gas, which is regasified and then supplied to consumers, so as to fit the heating value according to the Wobbe Index. The Wobbe Index (WI), an index for indicating input heat energy of gas to a combustor, is defined as a function of the heating value and the specific gravity, and used as an indicator of the interchangeability of fuel gases.

Accordingly, a marine structure having an LNG regasification facility is desirable to be additionally provided with an apparatus for producing nitrogen to be mixed with the natural gas regasified. Since a marine structure having an LNG regasification facility has a limited space, it is desirable that an apparatus for producing nitrogen is small in size and produces nitrogen by a simple process.

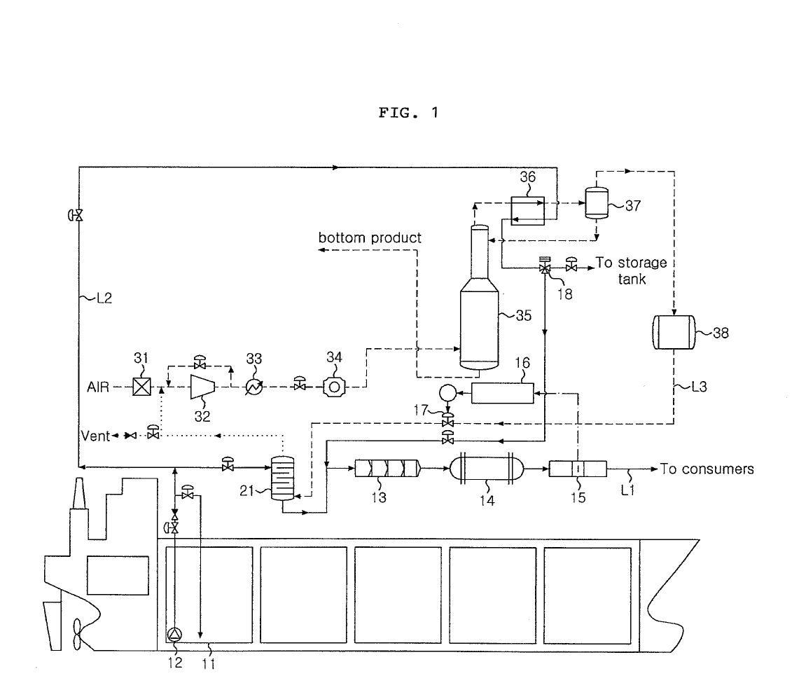

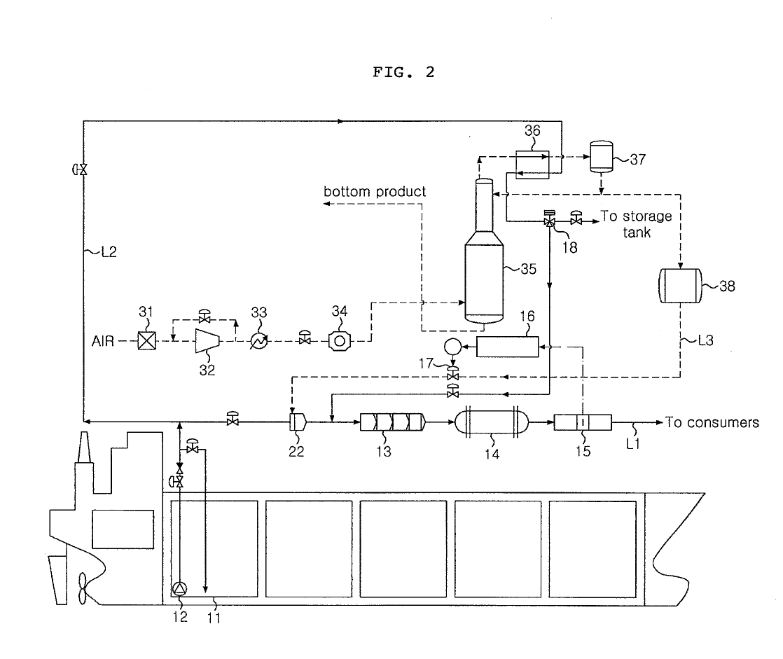

A off-shore plant with the apparatus for producing nitrogen equipped in a marine structure, and a method for supplying vaporized and diluted LNG from a marine structure using the apparatus, according to embodiments of the present invention, will be described in detail below with references to FIGS. 1 and 2.

FIG. 1 is a schematic diagram of an apparatus for producing nitrogen, equipped in a marine structure, according to an embodiment of the present invention. The apparatus for producing nitrogen according to an embodiment uses the LNG stored in a storage tank as a coolant for separating nitrogen from the atmosphere so as to produce nitrogen.

FIG. 1 shows an LNG RV as a marine structure having an LNG regasification facility, but an LNG FSRU can also be used as a marine structure. The LNG RV is an LNG carrier with an LNG regasification facility which is capable of sailing under its own power and floating, and the LNG FSRU is a floating offshore vessel which is incapable of sailing under its own power. In such marine structures, a high-pressure pump 13 and a vaporizer 14 are installed on a natural gas supply line L1 so as to regasify the LNG stored in a storage tank 11 and then supply the LNG to consumers on land.

The high-pressure pump 13 is to compress LNG at a high pressure before regasification of the LNG, and the vaporizer 14 is to vaporize the LNG compressed at a high pressure into natural gas. The storage tank 11 has an LNG pump 12 for supplying the LNG in the storage tank toward the high-pressure pump 13. The LNG pumped outside the storage tank 11 passes through a nitrogen absorber 21 before being supplied to the high-pressure pump 13 so that an appropriate amount of nitrogen can be mixed with the LNG.

A measuring device 15 for measuring the flow rate and Wobbe Index of natural gas to be supplied to consumers is installed at the downstream portion of the vaporizer 14. The information measured by the measuring device 15 is transmitted to a controller 16, and the controller 16 controls a nitrogen valve 17 to control the amount of nitrogen to be mixed with the vaporized natural gas.

The apparatus for producing nitrogen according to an embodiment of the present invention, which is installed on a nitrogen supply line L3 for mixing nitrogen with LNG by separating nitrogen from the atmosphere and supplying the nitrogen to a nitrogen absorber 21, will be described below with reference to the accompanying drawing.

As illustrated in FIG. 1, the apparatus for producing nitrogen according to an embodiment of the present invention comprises: an air compressor 32 for compressing the air supplied through a filter; an intermediate heat exchanger 33 for cooling the high-temperature compressed air; an impurity remover 34 for removing impurities such as H2O, CO2, HC, and Hg from the compressed air; and a distillation tower 35 for separating the compressed air into N2, O2, and Ar.

Air before being compressed, sea water, or fresh water can be used as a coolant for cooling the high-temperature compressed air in the intermediate heat exchanger 33.

The apparatus for producing nitrogen according to an embodiment of the present invention further comprises: an LNG heat exchanger 36 for partially condensing an overhead product such as N2 which has been separated in the distillation tower 35; a vapor-liquid separator 37 for separating the partially condensed overhead product into gas and liquid; and a buffer tank 38 for temporarily storing the separated gas.

A bottom product separated in the distillation tower 35, which is a byproduct, can be used in another apparatus in accordance with circumstances. Also, from the vapor-liquid separator 37, the liquid is returned to the distillation tower 35, and the gas is supplied to the nitrogen absorber 21 for mixing nitrogen with LNG.

The nitrogen which has not been absorbed by the nitrogen absorber 21 is exhausted through an exhaust valve, or can be mixed with the air, which is supplied from the atmosphere, at an upstream portion of the air compressor 32.

According to an embodiment of the present invention, an appropriate amount of nitrogen can be mixed with the LNG in the nitrogen absorber 21 by supplying the nitrogen separated from the air to the nitrogen absorber 21 installed upstream of the high-pressure pump 13.

The amount of nitrogen to be mixed with the LNG can be controlled by opening and closing a nitrogen valve 17 which is controlled by a controller 16 based on the information measured by the measuring device 15.

To separate nitrogen from the air in the distillation tower 25 on the nitrogen supply line L3, cold heat is supplied to the compressed air supplied to a lower end of the distillation tower 35 to cool the compressed air, and the cold heat for condensing air, according to an embodiment of the present invention, is obtained from the LNG stored in the storage tank 11

That is to say, according to an embodiment of the present invention, the LNG heat exchanger 36 is supplied with a portion of the LNG supplied to the high-pressure pump 13 through a bypass line L2 which is branched from the natural gas supply line L1 for supplying natural gas to consumers.

The LNG heat exchanger 36 exchanges heat between the overhead product from the distillation tower 35 and the LNG, and consequently the LNG is heated and the overhead product is cooled and partially condensed.

The low-temperature partially-condensed overhead product is supplied to the vapor-liquid separator 37, and the low-temperature liquid separated in the vapor-liquid separator 37 is returned to the distillation tower 35. The air in the distillation tower 35 can be supplied with cold heat from the low-temperature liquid (i.e. the low-temperature condensed overhead product in a liquid state) supplied from the vapor-liquid separator 37.

The low-temperature liquid, which has been separated in the vapor-liquid separator 37 and then supplied to an upper end of the distillation tower, flows downwardly toward a lower portion of the distillation tower 35, and the compressed air which has been supplied to a lower end of the distillation tower 35 flows upwardly toward an upper portion of the distillation tower 35, so that the gaseous components contained in the air can be separated in the distillation tower 35 according to their boiling points.

The LNG which has passed through the LNG heat exchanger 36 is returned to the storage tank 11 via a three-way valve 18, or mixed with the LNG, which is supplied from the storage tank 11, at an inlet of the high-pressure pump 13, and then supplied to the high-pressure pump 13.

The method for producing nitrogen in a marine structure using the apparatus for producing nitrogen, equipped in a marine structure, according to an embodiment of the present invention as stated above will be described below.

First, the air which has passed through a filter 31 is compressed by the air compressor 32, and then the compressed air whose temperature and pressure have increased during compression is cooled in the intermediate heat exchanger 33. The compressed and then cooled air continuously passes through the impurity remover 34, by which impurities such as H2O, CO2, HC, and Hg are removed from the compressed air, and then is supplied to the lower end of the distillation tower 35.

The air supplied to the distillation tower 35 is separated into N2 , O2, and Ar, and then discharged as an overhead product or a bottom product from the upper portion or the lower portion of the distillation tower 35. The overhead product containing nitrogen (the overhead product does not consist only of nitrogen, but consists mostly of nitrogen; consequently the overhead product will be considered nitrogen in the description below) is supplied to the LNG heat exchanger 36 and then exchanges heat with the LNG supplied from the storage tank 11, thereby being cooled and partially condensed.

The partially condensed overhead product, that is, nitrogen, is separated into gas and liquid, that is, nitrogen gas and liquefied nitrogen in the vapor-liquid separator 37, and then the liquid is returned to the distillation tower 35 to cool the air in the distillation tower, and the gas is stored in the buffer tank 38.

The nitrogen gas stored in the buffer tank 38, whose supply is controlled according to the opening and closing of the nitrogen valve 17, is supplied to the nitrogen absorber 21 on the natural gas supply line L1, and the nitrogen is mixed with the LNG in the nitrogen absorber 21 and then the Wobbe Index of the LNG is controlled to be appropriate for being used by consumers.

The nitrogen gas which has not been absorbed in the LNG in the nitrogen absorber 21 is exhausted to the atmosphere, or mixed with the air of the nitrogen supply line L3 at an upstream portion of the air compressor 32.

The LNG, which has absorbed an appropriate amount of nitrogen in the nitrogen absorber 21, sequentially passes through the high-pressure pump 13, the vaporizer 14, and the measuring device 15, and then is supplied to consumers.

In addition, according to an embodiment of the present invention, LNG is utilized as a coolant for cooling the overhead product, that is, nitrogen from the distillation tower 35 in the LNG heat exchanger 36 so as to partially condense the nitrogen. To do this, a portion of the LNG which is supplied from the storage tank 11 to the high-pressure pump 13 by the LNG pump 12 is bypassed and then sent to the LNG heat exchanger 36.

The LNG, whose temperature is increased after the nitrogen is supplied with cold heat from the LNG heat exchanger 36 and partially condensed, is returned to the storage tank 11 via the three-way valve 18, or mixed with the LNG, which is supplied to the high-pressure pump 13, at an upstream portion of the high-pressure pump 13.

As stated above, an embodiment of the present invention provides an apparatus and a method for producing nitrogen to be mixed with natural gas regasified, the apparatus being equipped in a marine structure having an LNG regasification facility.

Also, an embodiment of the present invention provides an apparatus and a method for producing nitrogen in which cold heat used to produce nitrogen in the apparatus is secured by supplying a portion of the LNG, which has been supplied to the high-pressure pump 13 through the bypass line L2 branched from the natural gas supply line L1 for supplying natural gas to consumers, to the LNG heat exchanger 36.

As stated above, an embodiment of the present invention provides an apparatus for producing nitrogen which is small in size, and a method for producing nitrogen by a simple process, which can be advantageously used in a marine structure having a small space, because of bypassing LNG and utilizing the LNG as a coolant needed in the apparatus.

An off-shore plant with the apparatus for producing nitrogen according to an embodiment of the present invention will be described below with reference to FIG. 2. In the apparatus and method for producing nitrogen according to an embodiment shown in FIG. 1 as stated above, nitrogen gas is mixed with LNG, but in the apparatus and method for producing nitrogen according to an embodiment shown in FIG. 2, liquefied nitrogen is mixed with LNG. The reference numerals used in the description of an embodiment of the present invention shown in FIG. 1 will also be used in the following description of an embodiment of the present invention shown in FIG. 2.

FIG. 2 is a schematic diagram of an apparatus for producing nitrogen, equipped in a marine structure, according to an embodiment of the present invention. The apparatus for producing nitrogen, equipped in a marine structure, according to an embodiment of the present invention uses the LNG stored in a storage tank as a coolant for separating nitrogen from the atmosphere and producing nitrogen.

FIG. 2 shows an LNG RV as a marine structure having an LNG regasification facility, but an LNG FSRU can also be used as a marine structure. The LNG RV is an LNG carrier with an LNG regasification facility which is capable of sailing under its own power and floating, and the LNG FSRU is a floating offshore vessel which is incapable of sailing under its own power but capable of floating offshore. In such marine structures, a high-pressure pump 13 and a vaporizer 14 are installed on a natural gas supply line L1 so as to regasify the LNG stored in a storage tank 11 and then supply the LNG to consumers on land.

The high-pressure pump 13 is to compress LNG at a high pressure before regasification of the LNG, and the vaporizer 14 is to vaporize the LNG compressed at a high pressure into natural gas. The storage tank 11 has an LNG pump 12 for supplying the LNG in the storage tank toward the high-pressure pump 13. The LNG pumped outside the storage tank 11 passes through a nitrogen absorber 21 before being supplied to the high-pressure pump 13 so that an appropriate amount of nitrogen can be mixed with the LNG.

The vaporizer 14 has at its downstream portion a measuring device 15 for measuring the flow rate and Wobbe Index of natural gas to be supplied to consumers. The information measured by the measuring device 15 is transmitted to a controller 16, and the controller 16 controls a nitrogen valve 17 to control the amount of nitrogen to be mixed with the vaporized natural gas.

The apparatus for producing nitrogen according to an embodiment having a nitrogen supply line L3 for mixing nitrogen with LNG by separating nitrogen from the atmosphere and supplying the nitrogen to a nitrogen absorber 21 will be described below with reference to the accompanying drawing.

As illustrated in FIG. 2, the apparatus for producing nitrogen according to an embodiment of the present invention comprises: an air compressor 32 for compressing the air supplied through a filter; an intermediate heat exchanger 33 for cooling the high-temperature compressed air; an impurity remover 34 for removing impurities such as H2O, CO2, HC, and Hg from the compressed air; and a distillation tower 35 for separating the compressed air into N2 , O2, and Ar.

Air before being compressed, sea water, or fresh water can be used as a coolant for cooling the high-temperature compressed air in the intermediate heat exchanger 33.

The apparatus for producing nitrogen according to an embodiment of the present invention further comprises: an LNG heat exchanger 36 for condensing an overhead product such as N2 which has been separated in the distillation tower 35; a vapor-liquid separator 37 for temporarily storing the condensed overhead product; and a buffer tank 38.

According to an embodiment of the present invention, approximately 99% or more of the overhead product is condensed in the LNG heat exchanger 36, and a very small amount of gaseous component which has not been condensed is contained in the condensed liquid and flows together with the condensed liquid. Accordingly, the vapor-liquid separator 37 according to an embodiment is used to temporarily store the condensed overhead product, and then to return a portion of the overhead product to the distillation tower 35 and to supply the remaining portion of the overhead product to the nitrogen mixer 22 via the buffer tank 38, rather than to separate the condensed overhead product into gas and liquid.

Also, in an embodiment of the present invention, the vapor-liquid separator 37 is omitted, and another buffer tank (not illustrated), instead of the vapor-liquid separator 37, may additionally be installed. In this case, the additionally installed buffer tank (not illustrated) or the existing buffer tank 38 may be used to temporarily store the condensed overhead product therein, and then to return a portion of the overhead product to the distillation tower and to supply the remaining portion of the overhead product to the nitrogen mixer 22.

A bottom product separated in the distillation tower 35, which is a byproduct, can be used in another apparatus in accordance with circumstances. Also, a portion of the liquid in the vapor-liquid separator 37 is bypassed and returned to the distillation tower 35. That is, the condensed overhead product in a liquid state, that is, liquefied nitrogen is supplied from the vapor-liquid separator 37 to the nitrogen mixer 22 for mixing nitrogen with the LNG, and a portion of the liquid is bypassed and returned to the distillation tower 35.

According to an embodiment of the present invention, an appropriate amount of nitrogen can be mixed with the LNG in the nitrogen absorber 21 by liquefying the nitrogen separated from the air and supplying the liquefied nitrogen to the nitrogen absorber 21 installed upstream of the high-pressure pump 13.

The amount of nitrogen to be mixed with the LNG can be controlled by opening and closing a nitrogen valve 17 which is controlled by a controller 16 based on the information measured by the measuring device 15.

To separate nitrogen from the air in the distillation tower 25 on the nitrogen supply line L3, cold heat is supplied to the compressed air supplied to a lower end of the distillation tower 35 to cool the compressed air, and the cold heat for compressing air, according to an embodiment of the present invention, is obtained from the LNG stored in the storage tank 11.

That is to say, according to an embodiment of the present invention, the LNG heat exchanger 36 is supplied with a portion of the LNG supplied to the high-pressure pump 13 through a bypass line L2 which is branched from the natural gas supply line L1 for supplying natural gas to consumers.

The LNG heat exchanger 36 exchanges heat between the overhead product from the distillation tower 35 and the LNG, and consequently the LNG is heated and the overhead product is cooled and condensed.

The low-temperature condensed overhead product is supplied to the vapor-liquid separator 37, and the low-temperature liquid separated in the vapor-liquid separator 37 is returned to the distillation tower 35. The air in the distillation tower 35 can be supplied with cold heat from the low-temperature liquid (i.e. the low-temperature condensed overhead product in a liquid state) supplied from the vapor-liquid separator 37.

The low-temperature liquid, which has been separated in the vapor-liquid separator 37 and then supplied to an upper end of the distillation tower, flows downwardly toward a lower portion of the distillation tower 35, and the compressed air which has been supplied to a lower end of the distillation tower 35 flows upwardly toward an upper portion of the distillation tower 35, so that the gaseous components contained in the air can be separated in the distillation tower 35 according to their boiling points.

The LNG which has passed through the LNG heat exchanger 36 is returned to the storage tank 11 via a three-way valve 18, or mixed with the LNG, which is supplied from the storage tank 11, at an inlet of the high-pressure pump 13, and then supplied to the high-pressure pump 13.

The method for producing nitrogen in a marine structure using the apparatus for producing nitrogen, equipped in a marine structure, according to an embodiment of the present invention as stated above will be described below.

First, the air which has passed through a filter 31 is compressed by the air compressor 32, and then the compressed air whose temperature and pressure have increased during compression is cooled in the intermediate heat exchanger 33. The compressed and then cooled air continuously passes through the impurity remover 34, by which impurities such as H2O, CO2 , HC, and Hg are removed from the compressed air, and then is supplied to the lower end of the distillation tower 35.

The air supplied to the distillation tower 35 is separated into N2 , O2 , and Ar, and then discharged as an overhead product or a bottom product from the upper portion or the lower portion of the distillation tower 35. The overhead product containing nitrogen (the overhead product does not consist only of nitrogen, but consists mostly of nitrogen; consequently the overhead product will be considered nitrogen in the description below) is supplied to the LNG heat exchanger 36 and then exchanges heat with the LNG supplied from the storage tank 11, thereby being cooled and condensed.

The condensed overhead product, that is, nitrogen, is temporarily stored in the vapor-liquid separator 37, and a portion of the nitrogen is bypassed and returned to the distillation tower 35 and used to cool the air in the distillation tower, and the remaining portion of the nitrogen is supplied to the buffer tank 38.

The liquefied nitrogen stored in the buffer tank 38, whose supply is controlled according to the opening and closing of the nitrogen valve 17, is supplied to the nitrogen absorber 21 on the natural gas supply line L1, and the nitrogen is mixed with the LNG in the nitrogen absorber 21 and then the Wobbe Index of the LNG is controlled to be appropriate for being used by consumers.

The LNG, which has absorbed an appropriate amount of nitrogen by the nitrogen absorber 21, sequentially passes through the high-pressure pump 13, the vaporizer 14, and the measuring device 15, and then supplied to consumers.

In addition, according to an embodiment of the present invention, LNG is utilized as a coolant for cooling the overhead product, that is, nitrogen from the distillation tower 35 in the LNG heat exchanger 36 so as to condense the nitrogen. To do this, a portion of the LNG which is supplied from the storage tank 11 to the high-pressure pump 13 by the LNG pump 12 is bypassed and then sent to the LNG heat exchanger 36.

The LNG, whose temperature is increased after the nitrogen is supplied with cold heat from the LNG heat exchanger and condensed, is returned to the storage tank 11 via the three-way valve 18, or mixed with the LNG, which is supplied to the high-pressure pump 13, at the upstream portion of the high-pressure pump 14.

As stated above, an embodiment of the present invention provides an apparatus and a method for producing nitrogen to be mixed with natural gas regasified, the apparatus being equipped in a marine structure having an LNG regasification facility.

Also, an embodiment of the present invention provides an apparatus and a method for producing nitrogen in which cold heat used to produce nitrogen in the apparatus is secured by supplying a portion of the LNG, which has been supplied to the high-pressure pump 13 through the bypass line L2 branched from the natural gas supply line L1 for supplying natural gas to consumers, to the LNG heat exchanger 36.

As stated above, an embodiment of the present invention provides an apparatus for producing nitrogen which is small in size, and a method for producing nitrogen by a simple process, which can be advantageously used in a marine structure having a small space, because of bypassing LNG and utilizing the LNG as a coolant needed in the apparatus.

Although the specific embodiments of the present invention have been described herein with references to the accompanying drawings, it should be understood that various modifications, variations or corrections may readily occur to those skilled in the art, and thus the description and the drawings herein should be interpreted by way of illustrative purpose without limiting the scope and spirit of the present invention.

What is claimed is:

1. An offshore LNG plant, comprising:
an LNG containing tank;
an N₂ generator configured to separate N₂ from air to a predetermined level of concentration;
a LNG processor in fluid communication with the tank and the N₂ generator, wherein the LNG processor is configured to vaporize and dilute a supply of LNG from the tank with a supply of N₂ from the N₂ generator so as to produce a vaporized and diluted form of LNG; and
a pipe configured to transfer the vaporized and diluted form of LNG from the LNG processor to an onshore network for supplying vaporized LNG.

2. The plant of claim 1, wherein the LNG processor comprises:
a mixer configured to mix the supply of LNG from the tank with the supply of N₂ from the N₂ generator so as to produce a diluted LNG; and
a vaporizer configured to vaporize the diluted LNG so as to produce the vaporized and diluted form of LNG, wherein the vapor supply pipe is configured to connect to an outlet of the vaporizer.

3. The plant of claim 1, wherein the LNG processor comprises:
a vaporizer configured to vaporize the supply of LNG from the tank; and
a mixer configured to mix the vaporized LNG with the supply of N₂ from the N₂ generator so as to produce the vaporized and diluted form of LNG, wherein the vapor supply pipe is configured to connect to an outlet of the mixer.

4. The plant of claim 1, wherein the offshore LNG plant is floating on water.

5. The plant of claim 1, wherein the offshore LNG plant is fixed to the seabed.

6. The plant of claim 1, wherein the offshore LNG plant is substantially stationary relative to the onshore network.

7. The plant of claim 1, wherein the predetermined level of N₂ concentration is from about 85 mole % to about 99 mole %.

8. The plant of claim 1, wherein the predetermined level of N₂ concentration is lower than 95 mole %.

9. The plant of claim 1, wherein the offshore LNG plant is provided in an LNG tank ship.

10. The plant of claim 1, wherein the LNG tank has a containing capacity greater than about 10,000 m³.

11. The plant of claim 1, wherein the LNG tank has a containing capacity greater than about 100,000 m³.

12. An LNG supply system comprising:
an offshore LNG plant comprising:
an LNG containing tank,
an N₂ generator configured to separate N₂ from air to a predetermined level of concentration,
a LNG processor in fluid communication with the tank and the N₂ generator, wherein the LNG processor is configured to vaporize and dilute a supply of LNG from the tank with a supply of N₂ from the N₂ generator so as to produce a vaporized and diluted form of LNG;
an onshore network for supplying vaporized LNG to consumers; and
a pipe interconnecting the offshore LNG plant to the onshore network and for transferring the vaporized and diluted form of LNG from the offshore LNG plant to the onshore network.

13. The system of claim 12, wherein the system does not comprise an onshore LNG tank containing liquid LNG with an associated liquefaction plant.

14. The system of claim 12, wherein the system does not comprise an onshore LNG tank containing liquid LNG with a storage capacity larger than 10,000 m³.

15. The system of claim 12, wherein the system does not comprise a liquefaction plant with a liquefaction capacity greater than 300 kg/hr.

16. A method of supplying LNG, the method comprising:
providing LNG contained in an offshore LNG tank;
producing N₂ to a predetermined level of concentration in an offshore N₂ generator, which separates N₂ from air;
vaporizing and diluting, in an offshore LNG processor, a supply of LNG from the offshore LNG tank with a supply of N₂ from the offshore N₂ generator, thereby producing vaporized and diluted LNG; and
transferring, via a pipe, the vaporized and diluted LNG from the offshore LNG processor to an onshore valve connected to a vaporized LNG distribution network.

17. The method of claim 16, wherein the offshore LNG tank, the offshore N₂ generator, the offshore LNG processor are provided in an LNG tank ship.

18. The method of claim 16, wherein the offshore LNG tank, the offshore N₂ generator, the offshore LNG processor are provided in a substantially stationary offshore LNG plant.

19. The method of claim 16, wherein the method does not comprise liquefying the vaporized and diluted LNG to store liquid LNG in an onshore LNG tank.

20. The method of claim 16, wherein the method does not comprise liquefying the vaporized and diluted LNG onshore with a liquefaction capacity greater than 3000 kg/hr.

21. A marine structure comprising:
an LNG tank storing liquefied natural gas (LNG);
an LNG vaporizer configured to vaporize LNG from the tank; and
a N₂ apparatus configured to provide N₂ to dilute the LNG prior to supplying to consumers, the apparatus comprising:
a distillation tower configured to separate N₂ from air, and
an LNG heat exchanger configured to use LNG from the tank so as to cool the separated N₂ to condense at least part of the separated N₂,
wherein the apparatus is configured to return at least part of the cooled N₂ to the distillation tower so as to cool air introduced into the distillation tower.

22. The marine structure of claim 21, wherein the apparatus further comprises a vapor separator configured to separate a gaseous portion from the cooled N₂; and
wherein the marine structure further comprises a N₂ absorber configured to absorb the gaseous N₂ for adding to LNG prior to LNG vaporization.

23. The marine structure of claim 22, further comprising a N₂ exhaust valve configured to discharge the N₂, which has not been absorbed in the N₂ absorber.

24. The marine structure of claim 22, further comprising a N₂ pipe configured to return the N₂, which has not been absorbed in the N₂ absorber, to the distillation tower.

25. The marine structure of claim 21, further comprising a N₂ mixer configured to mix LNG prior to vaporization with at least part of the condensed N₂, which has not been returned to the distillation tower.
